(19) United States
(12) Patent Application Publication
(10) Pub. No.: US 2005/0045320 A1
(43) Pub. Date: Mar. 3, 2005

(54) Compact vehicle temperature control system

(75) Inventors: Gerald Richter, Aachen (DE); Thomas Ehlers, Krefeld (DE); Eckart Sievers, Frechen (DE)

Correspondence Address: BRINKS HOFER GILSON & LIONE/CHICAGO/COOK, PO BOX 10395, CHICAGO, IL, 60610, US

(73) Assignee: Visteon Global Technologies, Inc.

(21) Appl. No.: 10/647,521

(22) Filed: Aug. 25, 2003

(51) Int. Cl. B60H 3/00

(52) U.S. Cl. 165/202; 165/42; 165/43

(57) ABSTRACT

The present invention involves a compact vehicle temperature control system. The system includes a housing, an evaporator core and a heater core disposed in the housing, and a separation wall disposed between the evaporator core and heater core. The housing has an intake opening for air intake and an output opening for output air. The evaporator core is in fluid communication with the intake opening. The heater core is disposed downstream from the evaporator core and in fluid communication with the evaporator core, defining a space between the evaporator core and the heater core. The heater core has a first portion and a second portion. The separation wall has a first end and a second end. The first end is attached to the first portion of the heater core and extends therefrom along the length of the heater core in the space between the evaporator core and the heater core.

### BACKGROUND

The present invention relates to a vehicle temperature control system for the heating and cooling of a passenger compartment of a vehicle.

Vehicle temperature control systems or heating, ventilation, and air conditioning (“HVAC”) systems are known and have been widely used in the automotive industry. In HVAC systems, air is typically introduced through an intake opening and is directed to an evaporator core through a first channel from the intake opening for cooling the air passing though the evaporator core. A second channel directs the cooled air from the evaporator core and through a heater core where the air may be heated. The cooled air exits through an output opening.

Although the above-mentioned system is adequate, industry demands have challenged manufacturers in producing a more compact system. For instance, manufacturers have been challenged in placing the heater core and the evaporator core more closely together, since a closer configuration of the heater core and evaporator cove may result in undesirable condensation buildup on the heater core.

### SUMMARY

The present invention provides a vehicle temperature control system having a heater core and an evaporator core disposed relatively closer together without a direct path for water droplets between the heater core and evaporator core thus preventing undesirable condensation buildup on the heater core

The present invention is a vehicle temperature control system. The vehicle temperature control system comprises a housing, an evaporator core disposed in the housing, a heater core disposed in the housing and a separation wall. The housing has an air intake opening formed therethrough for air intake and an output opening formed therethrough for air output. The evaporator core is in fluid communication with and adjacent to the intake opening. The heater core is disposed downstream from and in fluid communication with the evaporator core. The heater core has a first end portion and a second end portion. The heater core and the evaporator core are in side by side relationship to define a space between the evaporator core and the heater. The separation wall has a first end and a second end. The first end of the separation wall is attached to the first portion of the heater core. The second of the separation wall extends along the length of the heater core into the space between the evaporator core and the heater core.

Further objects, features and advantages of the invention will become apparent from consideration of the following description and the appended claims when taken in connection with the accompanying drawings.

### BRIEF DESCRIPTION OF THE DRAWINGS

FIG. 1 is a perspective view of a vehicle temperature control system in accordance with one embodiment of the invention;

FIG. 2 is a cross-sectional side view of the vehicle temperature control system along line 2-2 of FIG. 1;

FIG. 3 is a cross-sectional side view of a vehicle temperature control system in accordance with another embodiment of the present invention;

FIG. 4 is a cross-sectional side view of a multi-zone vehicle temperature control system in accordance with yet another embodiment of the present invention; and

FIG. 5 is a cross-sectional side view of a multi-zone vehicle temperature control system in accordance with still another embodiment of the present invention.

### DETAILED DESCRIPTION

The present invention generally provides a vehicle temperature control system having a heater core and an evaporator core disposed relatively close together without experiencing undesirable condensation on the heater core. The vehicle temperature control system has a separation wall which prevents condensate from entering the heater core from the evaporator core, allowing for a relatively closer placement of the heater core to the evaporator core.

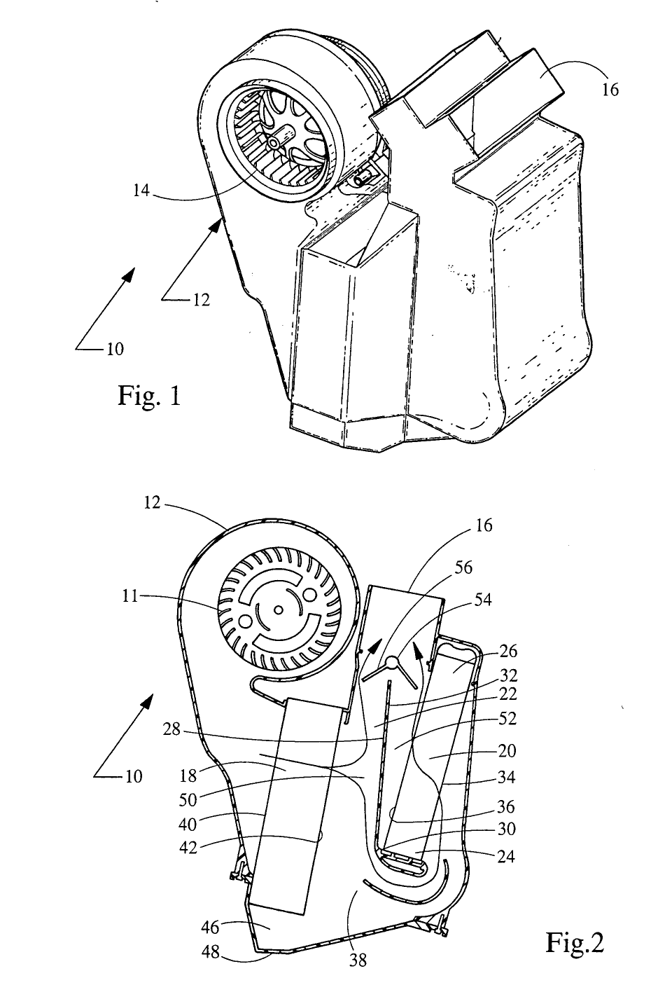

FIG. 1 illustrates a perspective view of a vehicle temperature control system 10 comprising of the housing 12. The housing 12 has an intake opening 14 for air intake and an output opening 16 for air output.

FIG. 2 illustrates a cross-sectional view of the vehicle temperature control system 10. As shown, system 10 includes a blower 11 at intake opening 14 for introducing ambient air or recycled air to the system 10. System 10 further includes an evaporator core 18 disposed within the housing 12 and downstream the blower 11. The evaporator core 18 is in fluid communication with the intake opening 14. As shown, the evaporator core 18 has an input side 40 and an output side 42.

Further, disposed within the housing 12 is a heater core 20 in a side relationship with evaporator core 18. In this embodiment, the heater core 20 is placed downstream and in fluid communication with the evaporator core 18. The heater core 20 has a first portion 24 and a second portion 26, and has an input face 34 and an output face 36. A space 22 is defined within the housing 12 between the evaporator core 18 and heater core 20.

System 10 further includes a separation wall 28 disposed within the housing. The separation wall 28 may be made of aluminum, steel, plastic, ceramic material, or any suitable material. As shown, the separation wall 28 has a first end 30 and a second end 32. The first end 30 of the separation wall 28 is attached to the first portion 24 of the heater core 20 and the second end 32 of the separation wall 28 extends along at least a portion of the length of the heater core 20 and into the space 22. The separation wall also has a width sufficient to separate air flow from the evaporator and heater cores. The separation wall 28 defines a flow channel 38 from the evaporator core 18 to the input face 34 of the heater core 20. The separation wall 28 isolates a cold air portion 50 and a hot air portion 52. The cold air portion 50 is adjacent to the evaporator core 18 and the hot air portion 52 is adjacent to the heater core 20.

The second end 32 of the separation wall 28 extends to a mixing channel 54 of the housing 12, wherein cool and hot air mix prior to exiting the system 10. Cool air flows from the evaporator core 18 through the cold air portion 50 to the mixing channel 54. Hot air flows from the heater core 20 through the hot air portion and mixes with cool air in the mixing channel 54.

As mentioned above, disposed within the housing is a blower 11. The blower 11 is disposed upstream from the evaporator core 18 for introducing either ambient air or recycled air into the input side 40 of the evaporator core 18. Condensation at the evaporator core 18 may be desired to drain area 46 formed within the housing 12 to hold condensate during normal use. The drain area 46 of the housing 12 is preferably below the evaporator core 18. A drain hole 48 is formed through the housing for condensation drainage.

In use, the blower 11 introduces through the intake opening 14 either ambient air or recycled air into the input side 40 of the evaporator core 18. The evaporator core 18 cools the air. The cooled air exits through the output side 42 of the evaporator core 18. From the output side 42 of the evaporator core 18, the air is split into a first air portion and a second air portion. The first air portion is directed to the mixing channel 54 through the cold air portion 50. The second air portion is directed towards to the flow channel 38. The second air portion in the flow channel 38 is then directed into the heater core 20 through the input face 34 of the heater core 20. The second air in the heater core 20 is heated and exits through the output face 36 of the heater core 20. The second air is then directed towards the mixing channel 54 through the hot air portion 52. The temperature door 56 restricts the amount of first air portion and second air portion entering the mixing channel 54. Once in the mixing channel 54, the first air and the second air portions mix to create the output air. The output air exits the housing 12 through the output opening 16.

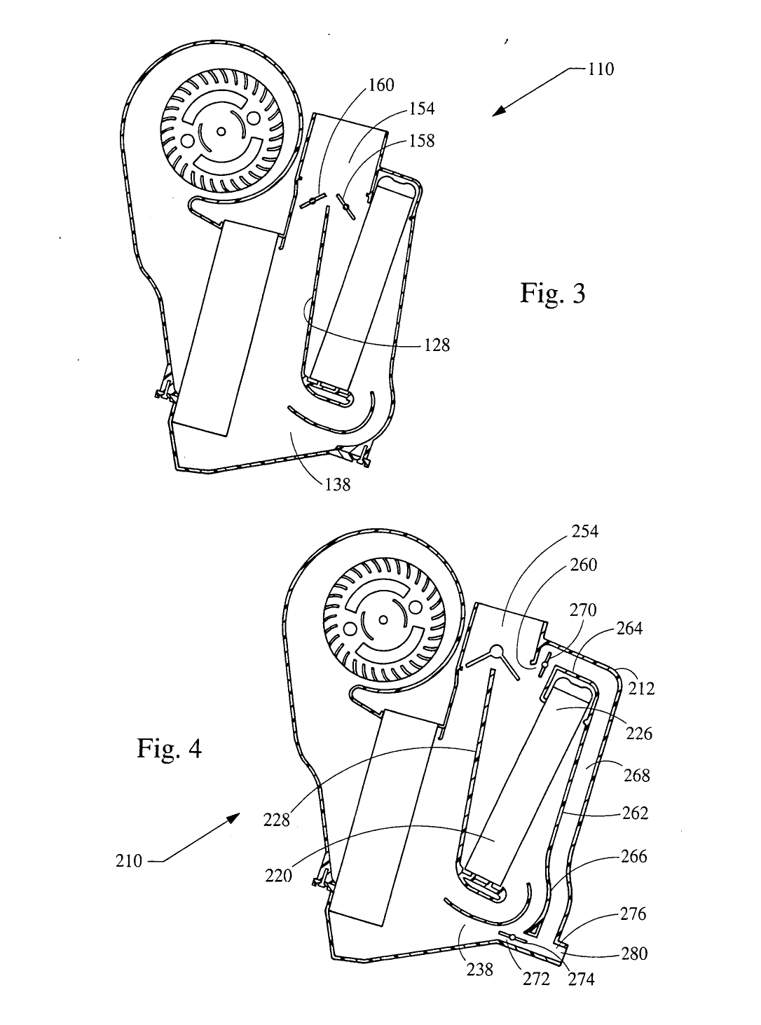

As shown, FIG. 3 provides a vehicle temperature control system 110 having similar members of the vehicle temperature control system 10 as shown in FIG. 2. For example, a mixing channel 154, a separation wall 128 and a flow channel 138 are the same as the mixing channel 54, the separation wall 28 and the flow channel 38 in FIG. 2, respectively. However, the vehicle temperature control system 110 has a hot temperature door 158 and a cold temperature door 160 in the mixing chamber 154. The hot temperature door 158 adjusts the flow of hot air into a mixing channel 154 and the cold temperature door 160 adjusts the flow of cold air into the mixing channel 154.

As shown, FIG. 4 provides a vehicle temperature control system 210 having similar members of the vehicle temperature control system 10 as shown in FIG. 2. For example, a first mixing chamber 254, a first separation wall 228 and a flow channel 238 are the same as the mixing chamber 54, the separation wall 28 and the flow channel 38 in FIG. 2, respectively. However, a second portion 226 of a heater core 220 is spaced apart from a housing 212, defining a hot air entrance 260. A second separation wall 262 having a first end 264 and a second end 266 is disposed within the housing 212. The first end 264 of the second separation wall 262 is attached to a second portion 226 of a heater core 220 and extends in the flow channel 238, defining a hot air channel 268. Disposed within the hot air channel 268 is a hot multi-zone door 270 that restricts the flow of hot air from the hot air entrance 260.

The second end 266 of the second separation wall 262 forms a cold air channel 272 from the flow channel 238. Disposed within the cold air channel 272 is a cold multi-zone door 274 that restricts the flow of cold air from an evaporator core 218. Disposed within the housing 212 and downstream and in fluid communication with the cold air channel 272 and the hot air channel 268 is a multi-zone mixing channel 276 for mixing cold air from the cold air channel 272 and hot air from the hot air channel 268 creating a mixed air. The mixed air from the multi-zone mixing channel 276 exits through a multi-zone output opening 280.

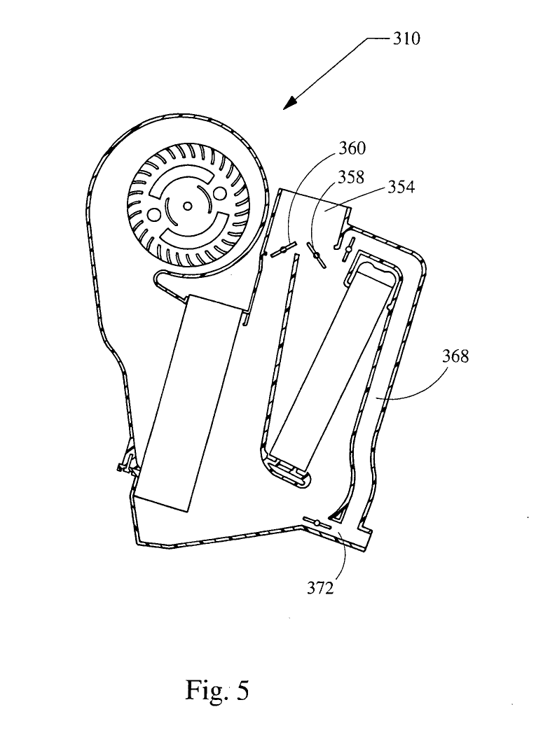

As shown, FIG. 5 provides a vehicle temperature control system 310 having similar members of the vehicle temperature control system 210 as shown in FIG. 4. For example, a hot air channel 368, a cold air channel 372 and a mixing channel 354 are the same as the hot air channel 268, the cold air channel 272 and a mixing channel 254 in FIG. 4, respectively. However, the vehicle temperature control system 310 has a hot temperature door 358 and a cold temperature door 360 in the mixing channel 354. The hot temperature door 358 adjusts the flow of hot air into the mixing channel 354 and the cold temperature door 360 adjusts the flow of cold air into the mixing channel 354.

While the present invention has been described in terms of preferred embodiments, it will be understood, of course, that the invention is not limited thereto since modifications may be made to those skilled in the art, particularly in light of the foregoing teachings.

1. A vehicle temperature control system, comprising:
a housing having an intake opening for air intake and an output opening for output air;
an evaporator core disposed in the housing and in fluid communication with the intake opening;
a heater core disposed in the housing downstream from the evaporator core and in fluid communication with the evaporator core, defining a space between the evaporator core and the heater core, the heater core having a first portion and a second portion; and
a separation wall having a first end and a second end, the first end being attached to the first portion of the heater core and extending therefrom along the length of the heater core in the space between the evaporator core and the heater core.

2. The system of claim 1 wherein the heater core has an input face and an output face and wherein the separation wall defines a flow channel from the evaporator core to the input face of the heater core.

3. The system of claim 1 wherein the evaporator core and the heater core are in side by side relationship.

4. The system of claim 1 wherein the evaporator core has an input side and an output side, the input side being adjacent to the intake opening and the output side being adjacent to the separation wall.

5. The system of claim 4 further comprising of a blower disposed in the housing and upstream from the evaporator core for introducing air into the input side of the evaporator core.

6. The system of claim 1 wherein the housing is a drain area adjacent to the evaporator core for condensation and a drain hole formed through the housing for condensation drainage.

7. The system of claim 1 wherein the separation wall isolates a cold air portion and a hot air portion of the space between the evaporator core and the heater core, the cold air portion being adjacent to evaporator core and the hot air portion being adjacent to the heater core.

8. The system of claim 7 wherein the separation wall defines a mixing channel for mixing cold air and hot air, the mixing channel being downstream and in fluid communication with the cold air portion and the hot air portion.

9. The system of claim 8 further comprising a temperature door disposed in the mixing channel and adjacent to the second end of the separation wall for adjusting a mixture of cold air and hot air.

10. The system of claim 9 wherein the temperature door further comprises a hot temperature door for adjusting hot air flow and a cold temperature door for adjusting cold air flow.

11. The system of claim 8 wherein the mixing channel is a first mixing channel and the separation wall is a first separation wall.

12. The system of claim 11, wherein the second portion of the heater core is spaced apart from the housing forming a hot air entrance.

13. The system of claim 12 further comprising a second separation wall having a first end an a second end, the first end being attached to the second portion of the heater core and extending therefrom along the length of the heater core in the flow channel defining a hot air channel.

14. The system of claim 13 further comprising a hot multi-zone door disposed inside the hot chamber to restrict hot air flow from the heater core.

15. The system of claim 14 wherein the second end of the second separation wall forms a cold air channel from the flow channel.

16. The system of claim 15 further comprising a cold multi-zone door disposed inside the cold air channel.

17. The system of claim 16 further comprising of a second mixing channel for mixing cold air from the cold channel and hot air and hot air from the hot channel, the second mixing channel being downstream and in fluid communication with the cold air channel and the hot air channel.
